(19) United States
(12) Patent Application Publication
(10) Pub. No.: US 2001/0034894 A1
(43) Pub. Date: Nov. 1, 2001

(54) Game hat

(76) Inventors: Kyle Godfrey, Palmdale, CA (US); Kurt Abrams, Palmdale, CA (US)

Correspondence Address: Matthew J. Peirce, Esq., 1550 Starlight Canyon Avenue, Las Vegas, NV, 89123, US

(21) Appl. No.: 09/827,471

(22) Filed: Apr. 6, 2001

Related U.S. Application Data
(60) Provisional application No. 60/195,119, filed on Apr. 6, 2000.

(51) Int. Cl. A42B 1/24; A42B 1/00; G09F 3/00

(52) U.S. Cl. 2/209.13; 2/195.1; 40/329

(57) ABSTRACT

A new and improved baseball hat is disclosed that has front-mounted removable patches which would allow a user to interchange different insignias, designs, or logos at the will of a user. The baseball hat itself would have a front-mounted Velcro patch which would be disc-shaped. In conjunction with the baseball hat, a user could use one of wide variety of patches, each of which would have a rear-mounted Velcro patch which could be removably attached to the front-mounted Velcro patch on the baseball hat. The patches would contain front-mounted designs, which would be different insignias, designs, or logos, either for the same sports team or for different sports teams. In addition to this, any type of theme or character could be used as well.

### I. BACKGROUND OF THE INVENTION

The present invention is that of a new and improved baseball hat that has front-mounted removable patches which would allow a user to interchange different insignias, characters, designs, or logos at the will of a user.

### II. DESCRIPTION OF THE PRIOR ART

U.S. Pat. No. 5,509,144, issued to Soergel et al., discloses a baseball cap configured to permit different logos to be interchangeably positioned on the cap.

U.S. Pat. No. 5,359,734, issued to Rathburn, discloses a versatile head gear system which includes a hat having a vertical wall in which an opening has been made.

U.S. Pat. No. 4,776,043, issued to Coleman, discloses an improved hat with interchangeable patches that can be selectively attached to the hat.

### III. SUMMARY OF THE INVENTION

The present invention is that of a new and improved baseball hat that has front-mounted removable patches which would allow a user to interchange different insignias, characters, designs, or logos at the will of a user. The baseball hat itself would have a front-mounted Velcro patch which would be disc-shaped. In conjunction with the baseball hat, a user could use one of wide variety of patches, each of which would have a rear-mounted Velcro patch which could be removably attached to the front-mounted Velcro patch on the baseball hat. The patches would contain front-mounted designs, which would be different insignias, designs, or logos, either for the same sports team or for different sports teams. In addition to this, any type of theme or character could be used as well.

There has thus been outlined, rather broadly, the more important features of a baseball hat in order that the detailed description thereof that follows may be better understood and in order that the present contribution to the art may be better appreciated. There are, of course, additional features of the baseball hat that will be described hereinafter and which will form the subject matter of the claims appended hereto.

In this respect, before explaining at least one embodiment of the baseball hat in detail, it is to be understood that the baseball hat is not limited in its application to the details of construction and to the arrangements of the components set forth in the following description or illustrated in the drawings. The baseball hat is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present baseball hat. It is important, therefore, that the claims be regard as including such equivalent constructions insofar as they do not depart from the spirit and scope of the present invention.

It is therefore an object of the present invention to provide a baseball hat which has all of the advantages of the prior art and none of the disadvantages.

It is another object of the present invention to provide a baseball hat which may be easily and efficiently manufactured and marketed.

It is another object of the present invention to provide a baseball hat which is of durable and reliable construction.

It is yet another object of the present invention to provide a baseball hat which is economically affordable and available for the public.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a front perspective view of a representative baseball hat used with the present invention.

FIG. 2 shows a front perspective view of a several possible representative models of patches used with the present invention

FIG. 3 shows a rear perspective view of a representative model of a patch used with the present invention.

FIG. 4 shows a front perspective view of a representative baseball hat used with the present invention, after a representative model of a patch has been removably attached to the front-mounted Velcro patch on the front of the baseball hat.

### V. DESCRIPTION OF THE PREFERRED EMBODIMENT

Referring now to FIG. 1, a front perspective view of baseball hat 2 is shown. Baseball hat 2 has two sides, a front side and a rear side, and has a front-mounted Velcro patch 4 which is located immediately above continuous bottom edge 5 on the front side of baseball hat 2. Velcro patch 4 would be sewn onto baseball hat 2, while baseball hat 2 would also have visor 3 attached to the continuous side edge 5 on the front side of baseball hat 2.

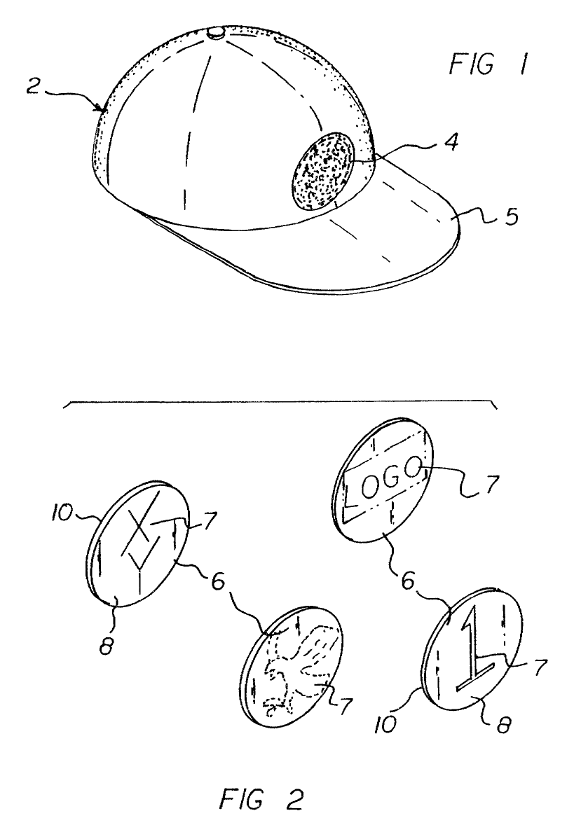

FIG. 2 shows a front perspective view of several possible representative models of patches 6 used with the present invention. Although all patches 6 shown in the various diagrams are circular, the present invention is not limited to only circular patches. Each patch 6 has a front face 8 and a rear face 10, with each patch 6 having a design 7 on the front face 8. Each design 7 would be made to represent an insignia, design, or logo of a particular sports team, or alternatively, could be some other design showing loyal fan support of a particular sports team. Alternatively, design 7 could be an insignia, design, or logo that would not be sports-related in nature.

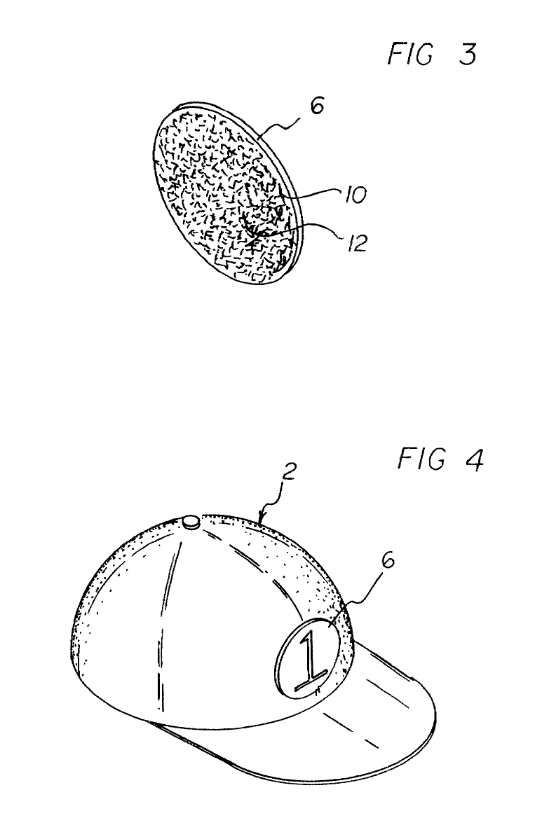

FIG. 3 shows a rear perspective view of a representative model of patch 6 used with the present invention. As can be seen, rear face 10 has Velcro patch 12 fixedly attached. Velcro patch 12 on rear face 10 is designed to be removably attached with Velcro patch 4 on baseball hat 2.

FIG. 4 shows a front perspective view of baseball hat 2 after a patch 6 has been removably attached to the front-mounted Velcro patch on the front of the baseball hat. As seen in this drawing, baseball hat 2 is ready to be worn by a loyal fan. If the fan decided to root for another sports team or another type of sport, the fan could change patch 6 to one that would be more appropriate.

The present invention is an improvement over the prior art because it does not require any change in manufacturing, as one patch of a two-patch hook and loops attachment system could be attached to the front of a cap, while the other patch of the two-patch hook and loops attachment system would be located on the back surface of the patch 6. In addition, no substantive modifications would need to be done to a baseball cap—any existing baseball cap could be used as part of the present invention. Further, the baseball cap of the present invention does not have any writing on it, thereby allowing an individual to use the baseball cap for a much wider variety of uses than prior existing art in the field of the invention. A user is not limited to using the present invention for only sports-related activities.

What I claim as my invention is:

1. A baseball hat comprising
(a) a cap portion having a continuous bottom edge, the cap portion also having a front side and a rear side,
(b) a visor portion attached to the continuous side edge on the front side of the cap portion,
(c) a patch having two sides, a front side and a rear side, the front side of the patch having a design, and
(d) attachment means for removably attaching the rear side of the patch to the front side of the cap portion.

2. A baseball hat according to claim 1 wherein the attachment means comprises a hook and loop attachment system, the system comprising a plurality of hooks and a plurality of loops, the plurality of hooks being attached to the front side of the cap portion in a concise grouping, the plurality of loops attached to the rear side of the patch, whereby the rear face of the patch is placed against the plurality of hooks.

3. A baseball hat according to claim 2 wherein the design on the front side of the patch would be a sports team design.

4. A baseball hat according to claim 2 wherein the design on the front side of the patch would be a sports team insignia.

5. A baseball hat according to claim 2 wherein the design on the front side of the patch would be a sports team logo.

6. A baseball hat according to claim 1 wherein the attachment means comprises a hook and loop attachment system, the system comprising a plurality of hooks and a plurality of loops, the plurality of loops being attached to the front side of the cap portion in a concise grouping, the plurality of hooks attached to the rear side of the patch, whereby the rear face of the patch is placed against the plurality of loops.

7. A baseball hat according to claim 6 wherein the design on the front side of the patch would be a sports team design.

8. A baseball hat according to claim 6 wherein the design on the front side of the patch would be a sports team insignia.

9. A baseball hat according to claim 6 wherein the design on the front side of the patch would be a sports team logo.

10. A baseball hat according to claim 1 wherein the patch would be circular in shape.
